(19) United States
(12) Patent Application Publication
(10) Pub. No.: US 2006/0233043 A1
(43) Pub. Date: Oct. 19, 2006

(54) TREATMENT PLANT

(75) Inventor: Werner Himmelsbach, Rheinfelden (DE)

Correspondence Address: Henry M. Feiereisen;Henry M. Feiereisen, LLC, Suite 4714, 350 Fifth Avenue, New York, NY, 10118, US

(73) Assignee: EKATO Ruhr- und Mischtechnik GmbH, Schopfheim (DE)

(21) Appl. No.: 11/279,685

(22) Filed: Apr. 13, 2006

(30) Foreign Application Priority Data
Apr. 14, 2005 (DE) 10 2005 017 327.6

(51) Int. Cl. B01F 7/20

(52) U.S. Cl. 366/147; 366/302

(57) ABSTRACT

A treatment plant in particular for a liquid medium of average to high viscosity, for example for production of pharmaceutical and cosmetic products includes a container in which an agitator, built-in structures, heat exchange elements, baffles or the like may be arranged. To reduce medium loss and to effectively clean such a treatment plant, any region or component of the treatment plant that comes into contact with the fluid medium is provided with a medium-repellent coating.

### CROSS-REFERENCES TO RELATED APPLICATIONS

This application claims the priority of German Patent Application, Serial No. 10 2005 017 327.6-23, filed Apr. 14, 2005, pursuant to 35 U.S.C. 119(a)-(d), the content(s) of which is/are incorporated herein by reference.

### BACKGROUND OF THE INVENTION

The present invention relates to a treatment plant for fluids of average to high viscosity but also for treatment of media of low viscosity.

Nothing in the following discussion of the state of the art is to be construed as an admission of prior art.

As a consequence of the high viscosity or a pronounced yield point, these media tend to adhere during emptying to the contact areas, such as the container wall, to built-in structures, such as baffles or heat exchange elements, to an agitator with agitator shaft and agitator blades. Examples of such media include adhesives or sealing materials (hot melts, silicone rubber, etc.), dyes and paints, cosmetics or pharmaceutical products, such as cremes, soaps, lotions, toothpaste etc., and foodstuffs, such as mustard, jam, nutrient fat and the like. Residues adhering in the treatment plant during emptying cause product loss and complicate a cleaning between the individual charges. This is time-consuming and cost-intensive. In particular when pharmaceutical and cosmetic products and foodstuffs are involved, highest standards are demanded as far as the reproducible purity is concerned so that the treatment plant and its components must be reliably cleansed.

It would therefore be desirable and advantageous to provide an improved treatment plant to obviate prior art shortcomings and to reduce product loss during emptying while allowing a reliable cleaning with reproducible highest purity.

### SUMMARY OF THE INVENTION

According to one aspect of the present invention, a treatment plant for a liquid medium, in particular of average to high viscosity, includes a member selected from the group consisting of a container for accommodating a liquid medium, an agitator received in the container, a built-in structure, a heat exchange element, and a baffle, wherein at least a region of the member that comes into contact with the liquid medium is provided with a medium-repellent coating.

The present invention resolves prior art problems by providing a region in contact with the medium with a medium-repellent coating on the surface of the region for realizing the structure to effect medium repellency.

According to another feature of the present invention, the medium-repellent coating has a medium repellency on the basis of lipophopy, hydrophoby, wetting angle phenomena, or lotus effect. As an alternative, photocatalysis or the like may be applicable as well. Also, the surface of the part in contact with the fluid medium may be configured optionally with a microstructure.

As the medium is prevented from adhering to at least most of those regions of the treatment plant according to the invention that come into contact with the fluid medium, product loss can be effectively reduced, when the treatment plant is emptied, and cleaning jobs in particular can be executed rapidly and more efficiently between the respective charges. Such a treatment plant thus meets the high standards demanded of purity and reproducibility of the purity. Therefore, such a treatment plant is especially appropriate for pharmaceutical and cosmetic products and for the preparation of foodstuffs. As a result of fewer residues, the strain on waste water is also diminished. The medium-repellent property is realized in particular on the vertical and inclined surfaces in the container of the treatment plant to repel the medium during emptying and drain it in accordance with the force of gravity. As a result, the medium can be discharged almost entirely together with the product mass in the container interior. Cleaning jobs and the complexity of cleaning are hereby also simplified because the surfaces and components of the treatment plant in contact with the medium are already substantially pre-cleaned.

According to another feature of the present invention, at least the region of the member may be made of metal, wherein the medium-repellent coating is applied on the metal region and composed to be hydrophobic, oleophobic, or a combination thereof.

According to another feature of the present invention, the medium-repellent coating may be a made of a material selected from the group consisting of glass-like coating based on nanoscale glass particles, fluoropolymer coating, combination of PTFE with silane and binder, sol-gel coating with hard chromium, baking enamel on the basis of diffusion-tight inorganic/organic nano-composite material with corrosion-inhibiting constituent in a matrix, and chemical linkage of the coating material to a base of the region, and coating with dispersion of fluorinated polyurethane. Fluoropolymer coating may hereby be sprayed onto the region, or realized as a plate coating.

According to another feature of the present invention, the member is an agitator having at least one agitator part projecting into the container, with the medium-repellent coating being applied upon a surface of the agitator part. Such an agitator may include agitator blades or helices or may include also a dissolver disk or a rotor-stator assembly.

Further fields of application for a treatment plant according to the present invention include also polymerization reactors in which contaminants on the surface of the regions that come in contact with the medium and are oftentimes made of steel act as catalyst. As a result, there is a tendency that polymer chains may grow on these regions. An example of application in the range of lower viscosities includes crystallizers in which products crystallize predominantly on the cooling surfaces so that heat transfer, yield and product quality deteriorate.

An essential feature of the present invention is the construction of a treatment plant in which essentially all regions that may come in contact with the medium, in particular in a container of such a treatment plant, have the property to repel the respective medium to enable a substantially full emptying of the treatment plant and in particular the container in the absence of any significant medium loss. At the same time, the complexity of cleaning is reduced as far as time expended as well as costs are concerned so as to realize and attain an effective cleaning of such a treatment plant to meet highest standards in connection with the reproducibility of the purity. This is especially of significant advantage when producing pharmaceutical and cosmetic products. As a consequence of the reduced cleaning times, it is also possible to reduce downtimes of such a treatment plant so that the treatment planet can be operated and utilized more efficiently.

### BRIEF DESCRIPTION OF THE DRAWING

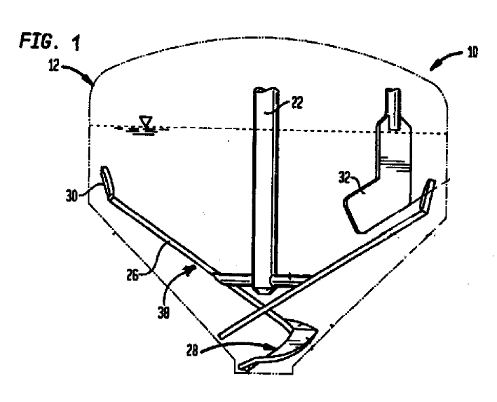

Other features and advantages of the present invention will be more readily apparent upon reading the following description of currently preferred exemplified embodiments of the invention with reference to the accompanying drawing, in which the sole FIG. 1 is a simplified schematic view of a treatment plant according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a simplified schematic view of a treatment plant according to the present invention, generally designated by reference numeral 10. The construction of the treatment plant 10 is shown here by way of example only, and the present invention should not be limited to the details shown here. The treatment plant 10 includes a container 12 whose outline is shown here only by way of a dash-dot line, and an agitator, generally designated by reference numeral 38 and including a driveshaft 22 which extends into the interior of the container 12 and supports blades 26. At least one of the blades 26 is provided with an added blade 28 and a side blade 30. Further received in the container 12 is a baffle 32 to reduce a rotational motion in the agitation product.

The container 12 may include a liquid medium of average to high viscosity to a level as indicated by the horizontal broken line. In accordance with the present invention, essentially all regions of the treatment plant 10 that may come in contact with the medium, such as vertical and inclined walls of the container 12, portions of the driveshaft 22, blade 26, 28, 30, baffle 32, are coated by a medium-repellent coating to repel the medium and thereby enable a substantially full emptying of the treatment plant 10 and in particular of the container 12. For sake of simplicity, the medium-repellent coating on the various surfaces has not been shown in detail.

The medium-repellent coating may be a made of a material selected from the group consisting of glass-like coating based on nanoscale glass particles, fluoropolymer coating, combination of PTFE with silane and binder, sol-gel coating with hard chromium, baking enamel on the basis of diffusion-tight inorganic/organic nano-composite material with corrosion-inhibiting constituent in a matrix, and chemical linkage of the coating material to a base of the region, and coating with dispersion of fluorinated polyurethane. Fluoropolymer coating may hereby be sprayed onto the region, or realized as a plate coating.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A treatment plant for a liquid medium, comprising a member selected from the group consisting of a container for accommodating a liquid medium, an agitator received in the container, a built-in structure, a heat exchange element, and a baffle, wherein at least a region of the member that comes into contact with the liquid medium is provided with a medium-repellent coating.

2. The treatment plant of claim 1, wherein the medium-repellent coating has a medium repellency on the basis of lipophopy, hydrophoby, wetting angle phenomena, or lotus effect.

3. The treatment plant of claim 1, wherein the region of the member is made of metal, said medium-repellent coating being applied on the metal region and composed to be hydrophobic, oleophobic, or a combination thereof.

4. The treatment plant of claim 1, wherein the medium-repellent coating is a made of a material selected from the group consisting of glass-like coating based on nanoscale glass particles, fluoropolymer coating, combination of PTFE with silane and binder, sol-gel coating with hard chromium, baking enamel on the basis of diffusion-tight inorganic/organic nano-composite material with corrosion-inhibiting constituent in a matrix, and chemical linkage of the coating material to a base of the region, and coating with dispersion of fluorinated polyurethane.

5. The treatment plant of claim 4, wherein the fluoropolymer coating is sprayed onto the region.

6. The treatment plant of claim 4, wherein the fluoropolymer coating is a plate coating.

7. The treatment plant of claim 1, wherein the agitator has at least one agitator part projecting into the container, said medium-repellent coating being applied upon a surface of the agitator part.

8. The treatment plant of claim 1, wherein the liquid medium is a fluid of average to high viscosity.

9. The treatment plant of claim 1, wherein the container has vertical and inclined surfaces, said medium-repellent coating being applied upon the vertical and inclined surfaces of the container to allow drainage of medium by gravity.

10. The treatment plant of claim 1, wherein the region has a microstructure.

11. A treatment plant for a liquid medium, comprising a container having an interior for accommodating a liquid medium; and a member received in the container and selected from the group consisting of agitator, built-in structure, heat exchange element, and baffle, wherein at least a region of the member that comes into contact with the liquid medium is provided with a medium-repellent coating.
